(19) United States
(12) Patent Application Publication
(10) Pub. No.: US 2008/0180524 A1
(43) Pub. Date: Jul. 31, 2008

(54) REMOTE MONITORING CONTROL METHOD OF NETWORK CAMERA

(75) Inventors: Fan-Sheng Lin, Taipei City (TW); Chun-Hsien Lee, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: ETROVISION TECHNOLOGY, Taipei City (TW)

(21) Appl. No.: 11/754,411

(22) Filed: May 29, 2007

(30) Foreign Application Priority Data
Jan. 31, 2007 (TW) 096103575

(51) Int. Cl. H04N 7/18

(52) U.S. Cl. 348/143; 348/E07.085

(57) ABSTRACT

A remote monitoring control method of a network camera is provided. The network camera is connected to an internal network host through a heterogeneous interface, and environmental parameters of the internal network host are automatically imported, so as to set the network camera. After the network camera is enabled, a network-address reporting procedure is executed, and an E-mail with a referral link generated based on the environmental parameters is transferred to an external local area network (LAN). An external monitoring host is directly connected to the network camera through the E-mail, so as to perform remote monitoring. In other words, the network camera is set and a remote monitoring is performed through the heterogeneous interface and the E-mail, such that the network camera can be easily enabled, and it is convenient for a user of the external network to perform remote monitoring.

### CROSS-REFERENCE TO RELATED APPLICATIONS

This non-provisional application claims priority under 35 U.S.C. § 119(a) on Patent Application No(s). 096103575 filed in Taiwan, R.O.C. on Jan. 31, 2007, the entire contents of which are hereby incorporated by reference.

### BACKGROUND OF THE INVENTION

1. Field of the Invention

The present invention relates to a remote monitoring control method of a network camera. More particularly, the present invention relates to a method of setting a network camera through a heterogeneous interface and achieving remote monitoring by directly controlling a network camera located in internal LAN from an external LAN.

2. Related Art

A network camera (or called IP Camera) is a picture-shooting device that is capable of transmitting images and sounds to a remote host through Internet. Currently, the network camera has been generally applied in networkized remote monitoring equipments (especially, surveillance equipments). For example, a network camera is mounted in the garden of a house for monitoring the surroundings, so as to avoid being stolen. Furthermore, being characterized in picture-shooting and transmitting audio/video in real time, the network camera is also applied in circumstances such as video conference. The network camera herein does not refer to the PC camera (or called Web Camera) that must be installed via a computer host, but it is a network camera having the network connection function itself. Besides a image-shooting device, the network camera further includes a microprocessor, a memory, and a network connection module (for example, a wired network interface card (NIC) or wireless NIC). Whenever the network camera is used for remote monitoring or two-way video conference, the network camera is firstly connected to a router. Next, the network camera executes the built-in firmware and adopts a default address originally set, or, an address is allocated to the network camera by the router. After that, through a host in the same domain that can provide a link to the network, a connection is established with the network camera, and the network parameters or other network camera settings (for example, wireless network parameters, image quality) are set. After a series of complicated settings, the user can carry out video monitoring by connecting a host in the internal network to the network camera. A certain host in the external network cannot establish connection for monitoring, unless the address set for the network camera itself is a public IP address. However, under limited network address resources, the public IP addresses are far from enough, such that the network camera is often set with a private IP address. Thus, through a router with a port forwarding function, the private IP address that can be used by the host is translated into a public IP address, so as to be connected to the Internet. If the network camera with a private IP address is to be connected at the Internet terminal through the router for remote monitoring/video conference, the Internet must be first connected to the router, and then, the address is translated into a private IP address through the router, so as to be connected to the network camera of the internal network. Under this circumstance, the public IP address/private IP address translation problem occurs when connecting the external network to the internal network. When performing the remote monitoring/video conference, the router converts the public IP address of the packet to be transmitted into a private IP address used by the internal network camera, so as to transmit the packet to the network camera; otherwise, the packet transmission cannot be done. The public IP address/private IP address translation problem is further illustrated below with reference to the drawings.

FIG. 1 is a schematic view of remote monitoring a network camera in an internal network according to the conventional art. Referring to FIG. 1, an example of the network address and the port number is shown. Environmental parameters (i.e., network configurations) of a network camera 110 are set as private network address, such as 192.168.1.1. During the process of remote monitoring, the network camera 110 establishes a connection with an external monitoring host 130 via a router 120. It is assumed that the router 120 supports the common network address translation (NAT) function, and the private network address 192.168.1.1 of the packet transmitted by the network camera 110 is translated to a public IP address, such as 213.31.218.101, when the packet passes through the router 120, and a used port 80 is changed into a new port number, such as 5001. As the IP address of all packets for a connection is translated from a private IP address into a public IP address through the router 120, the external monitoring host 130 can still return an acknowledge (ACK) packet to the network camera 110, even through the private network address used by the network camera 110 is unknown. However, in the remote monitoring application, the network address of the external monitoring host 130 varies depending upon the location of the monitor, such that the connection cannot be initiated from the network camera 110, but from the external monitoring host 130, so the above method for establishing a connection is not suitable. In other words, the external monitoring host 130 cannot initiate a connection with the network camera 110 for remote monitoring. In order to provide the network camera with a specific external network address for the monitor to enable a connection, some routers provides an NAT Traversal function (i.e., port forwarding). Continue referring to FIG. 1, the administrator of the router 120 manually sets to enable the port forwarding service at the administration interface, or enables the port forwarding service of the router 120 through the specific network protocol, for example, Universal Plug and Play (UPnP), via a machine at the internal network (such as, the network camera 110). Once the port forwarding service is set, the user is able to establish a connection with the network camera 110 at the internal network from any external monitoring host 130 at the external network, so as to perform remote monitoring. The remote monitoring performed through the port forwarding service is illustrated below with reference to the drawings.

However, currently, the problem challenging the remote monitoring lies in the complicated setup procedure when the network camera is installed for the first time, for example, setting environmental parameters (network configurations) of the network camera or enabling the port forwarding function of the router. Mostly, the network camera is mounted in the internal network, and normally the Internet Service Provider (ISP) cannot provide a fixed public IP address. Once the public IP address is dynamically changed by ISP, neither the monitoring client nor the internal network camera will be notified of the change of address. Further, some suppliers of the network camera build up a proprietary server for the network camera to periodically maintain its public address of network connection. However, the maintenance of the proprietary server costs manpower and money, and the user needs to master network knowledge and perform extra setting procedures, in order to achieve the configuration of the connection for remote monitoring.

### SUMMARY OF THE INVENTION

In view of the above problems, the present invention is directed to a method for remote monitoring setting and an enabling method of a network camera. The network camera is set and connected through a heterogeneous interface, and an E-mail is transferred to make a user at an external network to enable/control the network camera by clicking a referral link, so as to achieve the purpose of simply setting and enabling the network camera for remote monitoring.

In order to achieve the above object, the present invention provides a remote monitoring control method of a network camera, which utilizes a heterogeneous interface, for example, a USB interface or IEEE1394 interface, to set the environmental parameters (network configurations) required by the network camera, so as to remotely monitor the network camera at the internal LAN by any host of the external LAN. The method includes the following steps: firstly, the network camera is connected to an internal network host through the heterogeneous interface; next, the internal network host generates a network camera setting interface for receiving the input of several environmental parameters, or actively importing environmental parameters from the internal network host, and then, the environmental parameters are stored into the network camera through the heterogeneous interface; afterward, the network camera is enabled, and a network-address reporting procedure is started, so as to export the necessary environmental parameters into a referral link of an E-mail, and then, the E-mail is transferred to the external LAN; next, the E-mail is received by an external monitoring host and is opened, and the referral link is triggered to evoke an operation interface to establish a connection for remote monitoring; finally, the external monitoring host controls the network camera via the operation interface for remote monitoring (for example, a connection established for real time streaming data control protocol).

In view of the above, the above network-address reporting procedure includes the following steps: (a) enabling a network interface and determining a connection port to use; (b) determining whether a router can successfully activate the port forwarding function; (c) if failed, issuing an E-mail from the network camera about reasons for the reporting failure and the corresponding suggestions, and then, displaying a message indicating that the network address reporting fails with a lamp signal; otherwise, turn to Step (d), issuing an E-mail with a referral link from the network camera, and then, displaying a message indicating that the network address reporting is successful with a lamp signal. The referral link is displayed in the form of a hyperlink, in which an external address, an external connection port, a user account information, and a user password are displayed in the form of a plain code, or in the form of a cipher. In addition, when it is determined that the address of the internal network and the connection port are changed, or when it is determined to perform a routine check for reporting, or when it is determined that the router is reset, Step (b) of the network-address reporting procedure is repeated, so as to update the reporting information of the network address in real time or periodically.

The present invention sets and imports the environmental parameters through the heterogeneous interface, such as a USB or an IEEE1394 interface, and generates an E-mail with a referral link through a network-address reporting procedure, so as to issue the E-mail to the external network. After receiving the E-mail, the user of the external network triggers the remote control by clicking the referral link. Therefore, the present invention is characterized in easily enabling the network camera, making the network camera plug and play, performing remote control without additionally constructing a proprietary network server, and updating the network address information in real time in order to avoid the circumstance that the remote monitoring cannot be preformed.

The detailed features and practice of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification and drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of remote monitoring a network camera in an internal network according to the conventional art;

FIG. 2A is a first schematic view of a remote monitoring system of a network camera according to the present invention;

FIG. 2B is a second schematic view of a remote monitoring system of a network camera according to the present invention;

FIG. 3 is a flow chart of a remote monitoring control method of a network camera according to the present invention;

FIG. 4 is a flow chart of the process of the network-address reporting procedure according to the present invention; and

FIG. 5 is a schematic view of a referral link of an E-mail according to the present invention.

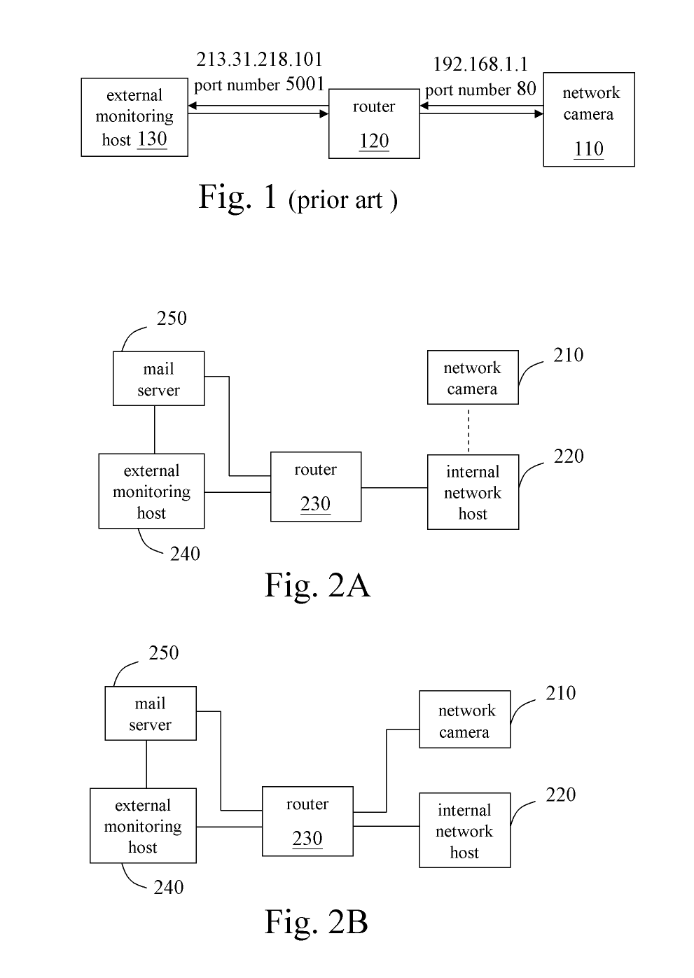

### DETAILED DESCRIPTION OF THE INVENTION

The objectives and implementing methods of the present invention will be described below in great detail with preferred embodiments. However, the concept of the present invention can also be applied to other scopes. The embodiments given below are only intended to illustrate the objectives and implementing methods of the present invention, instead of limiting the scope thereof.

First of all, the architectures of the network camera and the remote monitoring system of the network camera are described first. The architecture of a conventional network camera at least includes a camera module, an image compression unit, a CPU, and a network interface, which will not be further illustrated herein. Moreover, in the present invention, a storage medium (for example, a flash memory) storing a computer program for executing the remote monitoring control method is further added into the network camera. Thus, the network camera can automatically set the environmental parameters (network configurations) through any host in the internal network, and facilitate a user of the external network to remote monitor the network camera of the internal network through the computer program for executing the remote monitoring control method. The architecture of the system of the present invention is illustrated below with reference to the drawings.

FIG. 2A is a first schematic view of a remote monitoring system of a network camera according to the present invention. Referring to FIG. 2A, the remote monitoring system in this embodiment includes a network camera 210, an internal network host 220, a router 230, an external monitoring host 240, a mail server 250. First, the network camera 210 is connected to the internal network host 220 through a heterogeneous interface, such as a universal serial bus (USB) or an IEEE1394, for automatically importing the environmental parameters (network configurations) of the internal network host 220, or generating a network camera setting interface to set the environmental parameters (network configurations) of the network camera. FIG. 2B is a second schematic view of a remote monitoring system of a network camera according to the present invention. Referring to FIG. 2B, after the environmental parameters (network configurations) of the network camera are set, the connection of the heterogeneous interface between the network camera 210 and the internal network host 220 is removed, and then, the network camera 210 is connected to the router 230 through a network interface, for example, RJ-45 network line. At this time, the network camera 210 can be connected to the external monitoring host 240 through the router 230. In addition, after the network camera is enabled, a network message about the connection will be periodically reported, for example, an external address of the internal network used for external services (that is, an external public IP address), an external connection port, a user account, and a user password. In this embodiment, the periodically-reported network message is transferred through, for example, an E-mail. As shown in FIG. 2B, a mail server 250 exists in the external network, and after the network camera 210 transfers the E-mail to the mail server 250, the external monitoring host 240 can control the network camera 210 to perform remote monitoring through the E-mail. The remote monitoring control method of the network camera in this embodiment is implemented in the above system architecture. However, it is not restricted to send the E-mail through the mail server, and any server that is capable of sending a message, such as a short message service (SMS) server or instant messaging (IM) server can be used to replace the mail server, which is not intended to limit the scope of the present invention.

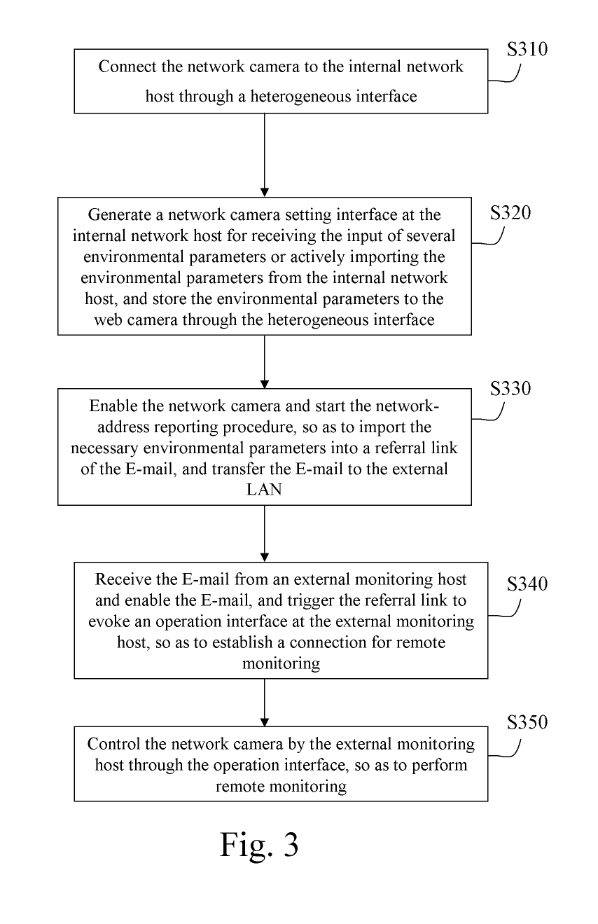

Then, the remote monitoring control method of the network camera of the present invention is illustrated below. FIG. 3 is a flow chart of a remote monitoring control method of a network camera according to the present invention. Referring to FIG. 3, the method includes the steps as follows. First of all, the network camera is connected to the internal network host through a heterogeneous interface (Step S310), in which the heterogeneous interface refers to a USB interface or an IEEE1394 interface for connecting different file systems. Next, a network camera setting interface is generated at the internal network host for receiving the input of several environmental parameters or actively importing the environmental parameters from the internal network host, and then, the environmental parameters are stored into the network camera through the heterogeneous interface (Step S320), in which the network camera setting interface can be, but not limited to, a web management interface executed on a browser. After the environmental parameters are set, the environmental parameters can be stored into the network camera through the heterogeneous interface. Then, the network camera is communicated with the external network by being connected to the router through, for example, an RJ-45 network line. Moreover, the network camera is enabled and the network-address reporting procedure is started to import the necessary environmental parameters to a referral link of an E-mail, and the E-mail is then transferred to the external LAN (Step S330). Afterward, the E-mail is received from any external monitoring host and is opened and the referral link is triggered to evoke an operation interface at the external monitoring host, so as to establish a connection for remote monitoring (Step S340), for example, establishing a connection of the real time streaming data control protocol which is controlled and executed by the web management interface of a browser. Finally, the external monitoring host controls the network camera through the operation interface, so as to perform remote monitoring (Step S350).

In view of the above, the environmental parameters loaded by the internal network host or inputted through the network camera setting interface brought about by the heterogeneous interface at least includes a wired LAN setting, a wireless LAN setting, a monitoring account setting, and a router function setting. The wired LAN setting includes setting a fixed or dynamic address and a connection port thereof. The wireless LAN setting at least includes a service set identifier (SSID) setting and a WEP key setting. The monitoring account setting is, for example, setting an E-mail account, setting an IM account, or setting a phone number. The router function setting includes detecting and enabling the UPnP function of an Internet Gateway Device (IGD). In this embodiment, a user can automatically activate the port forwarding function through a configuration file stored in the network camera while importing the environmental parameters, instead of manually activating the port forwarding function of the router.

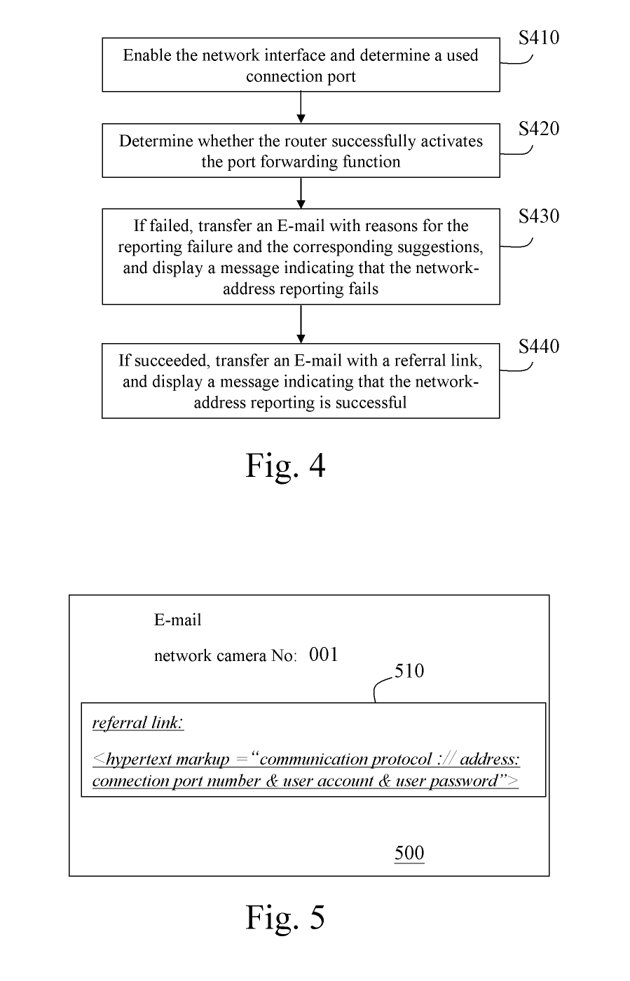

The most significant difference between the present invention and the conventional art is that, the present invention further executes the network-address reporting procedure to generate and transfer, for example, an E-mail or a short message to inform the monitor of the external network, and thus, the monitor of the external network initiates a remote monitoring action. The communication manners, such as E-mail and short message, are familiar to the mass, such that the monitor only needs to receive the E-mail (or short message) and operates (for example, clicking the network address) according to the content of the E-mail, without wasting extra time on learning and setting, so as to establish a connection with the network camera of the internal network. Afterward, the network-address reporting procedure is illustrated. FIG. 4 is a flow chart of the process of the network-address reporting procedure according to the present invention. Referring to FIG. 4, in this embodiment, the network-address reporting procedure includes the following steps: Step (a), enabling the network interface and determining a connection port to use (Step S410); Step (b), determining whether the router successfully activates the port forwarding function (Step S420); Step (c), if failed, transferring an E-mail with the failure reasons and the corresponding suggestions, and displaying a message indicating that the network-address reporting fails through a light signal (for example, the message indicating that the network-address reporting fails is displayed through a flickering light signal) (Step S430); Step (d), if succeeded, transferring an E-mail with a referral link, and displaying a message indicating that the network-address reporting is successful through another light signal (for example, the message indicating that the network-address reporting is successful is displayed through an un-flickering light signal) (Step 440).

In view of the above, as the external public IP address of the internal network or the used connection port number may be changed by the ISP, the network-address reporting procedure will be repeatedly executed periodically or non-periodically, so as to update the network address. For example, when it is determined that the address of the internal network and the connection port are changed, Step (b) is repeated, so as to determine whether the port forwarding function of the router is activated, and maintain and report the connection information such as the external public IP address to the user of the external network. Further, a routine check is periodically performed on the network-address reporting procedure, and when it is determined that the routine check is required to be performed or when it is determined that the router is reset, Step (b) is repeated, so as to update the above connection information and ensure the connection information to be correct.

In order to clearly explain the remote monitoring control method of the network camera according to the present invention, it is described in the following paragraphs through embodiments. FIG. 5 is a schematic view of a referral link of an E-mail according to the present invention. Together referring to FIG. 2B and FIG. 5, in this embodiment, the network camera 210 employs a private IP address 192.168.1.1 with a connection port number of 80, and the external monitoring host 240 employs a public IP address 213.31.10.1 with a connection port number of 80. It is assumed that the internal address and the connection port of the network camera are translated into an external address of 213.31.218.101 and a port number of 1234 through the port forwarding function of the router 230.

When the network camera 210 is connected to the internal network host 220 through, for example, a USB interface, a management interface is generated, which is called a network camera setting interface, and in the present invention, it is preferably a web management interface executed on a web browser. Then, environmental parameters (network configurations) of the internal network host 220, for example, the external address 213.31.218.101 and the port number 1234, are automatically imported, and then, the environmental parameters (network configurations) are stored into the network camera 210. Afterward, the connection between the network camera 210 and the internal network host 220 is removed, and the network camera 210 is connected to the router 230 (through a network cable or a wireless network). Once being enabled, the network camera 210 automatically starts a program of the network-address reporting procedure (the network-address reporting procedure has already been described above in detail, and will not be described herein again), and the environmental parameters (network configurations) are imported into the referral link of the E-mail, for transferring an E-mail with the referral link after the port forwarding function is activated, and displaying a message indicating that the network-address reporting is successful, for example, the light signal of the network camera 210 is not flickering. The E-mail 500 sent to the mail server 250 is stored in the form of, for example, a hyper text markup language (HTML), and the referral link 510 is, for example, in the form of a hyperlink. In this embodiment, the referral link at least includes the external address (for example, the public IP address 213.31.218.101) and the external connection port (for example, the connection port 1234) translated through the router 230. Further, the referral link includes a user account and a user password. The above external address, external connection port, user account, and user password are displayed in a plain code, or in a cipher, so as to ensure the safety of the data of the user with a connection. When the user of the external monitoring host 240 receives the E-mail 500 through a connection, the user can try establishing a connection for remote monitoring with the network camera 210 by clicking the referral link 510. After the connection for remote monitoring is established, an operation interface is brought about at the external monitoring host 240, for example, a web management interface of a browser, and the user can perform remote monitoring through the operation interface, which is not limited herein. In addition, if the external address (for example, 213.31.218.101) is changed by the ISP, after a fixed time period (the time length is determined depending on the frequency of the network-address reporting procedure), or once it is detected that the external network address is changed, the network camera 210 will re-execute the network-address reporting procedure and transfer an E-mail with a new referral link. The user of the external monitoring host 240 can restore the remote monitoring action through the new referral link.

To sum up, as for the remote monitoring control method of the network camera according to the present invention, environmental parameters (network configurations) of the connected host are input or automatically imported through a heterogeneous interface, such as a USB or an IEEE1394 interface, so as to finish the setting of the network camera. Moreover, currently available network resources (such as, an E-mail system) are reported to the user of an external network in real time or periodically through the network-address reporting procedure, and a referral link is generated for the user to click to bring about an operation interface for performing remote monitoring. Thus, the present invention has the following advantages of easily activating the connection for remote monitoring, making the network camera plug and play, enabling the user of the external network to perform remote monitoring without additionally constructing a proprietary service server, and enabling the user of the external network to update the network address information in real time when the external public IP address of the internal network is changed in order to avoid the circumstance that the remote monitoring cannot be preformed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote monitoring control method of a network camera, applicable for setting the network camera, so as to remote monitor an internal local area network (LAN) from an external LAN, the method comprising:
connecting the network camera to an internal network host of the internal LAN through a heterogeneous interface;
generating a network camera setting interface at the internal network host, for receiving input of several environmental parameters or actively importing the environmental parameters from the internal network host, and then, storing the environmental parameters into the network camera through the heterogeneous interface;
enabling the network camera, and starting a network-address reporting procedure for importing the necessary environmental parameters to a referral link of an E-mail, and then, transferring the E-mail to the external LAN;
receiving the E-mail from an external monitoring host of the external network, opening the E-mail, and triggering the referral link, so as to evoke an operation interface at the external monitoring host for establishing a connection for remote monitoring; and
controlling the network camera by the external monitoring host via the operation interface, for remote monitoring.

2. The remote monitoring control method of the network camera as claimed in claim 1, wherein the heterogeneous interface is a universal serial bus (USB) interface or an IEEE1394 interface.

3. The remote monitoring control method of the network camera as claimed in claim 1, wherein the internal LAN further comprises a router with a port forwarding function.

4. The remote monitoring control method of the network camera as claimed in claim 1, wherein the environmental parameters at least comprise a wired LAN setting, a wireless LAN setting, a monitoring account setting, and a router function setting.

5. The remote monitoring control method of the network camera as claimed in claim 4, wherein the wired LAN setting at least comprises a fixed address setting or a dynamic address setting.

6. The remote monitoring control method of the network camera as claimed in claim 4, wherein the wireless LAN setting at least comprises a service set identifier (SSID) setting and a WEP key setting.

7. The remote monitoring control method of the network camera as claimed in claim 4, wherein the monitoring account setting is an E-mail account setting, an instant messaging (IM) account setting, or a phone number setting.

8. The remote monitoring control method of the network camera as claimed in claim 4, wherein the router function setting comprises detecting and enabling a universal plug and play (UPnP) function of an Internet Gateway Device (IGD).

9. The remote monitoring control method of the network camera as claimed in claim 3, wherein the network-address reporting procedure comprises:
(a) enabling a network interface and determining a connection port to use;
(b) determining whether the router successfully activates the port forwarding function;
(c) if failed, transferring the E-mail with failure reasons and corresponding suggestions, and displaying a message indicating that a network-address reporting fails; and
(d) if succeeded, transferring the E-mail with the referral link, and displaying a message indicating that a network-address reporting is successful.

10. The remote monitoring control method of the network camera as claimed in claim 9, wherein the network-address reporting procedure further comprises repeating Step (b) when it is determined that an address of an internal network and a connection port are changed, the reporting needs a routine check, or the router is reset.

11. The remote monitoring control method of the network camera as claimed in claim 9, wherein the message indicating that a network-address reporting is successful is displayed with a light signal of the network camera.

12. The remote monitoring control method of the network camera as claimed in claim 9, wherein the message indicating that a network-address reporting fails is displayed with a light signal of the network camera.

13. The remote monitoring control method of the network camera as claimed in claim 1, wherein the referral link is displayed in a form of a hyperlink.

14. The remote monitoring control method of the network camera as claimed in claim 1, wherein the necessary environmental parameters imported into the referral link at least comprise an external address and an external connection port.

15. The remote monitoring control method of the network camera as claimed in claim 1, wherein the referral link further comprises a user account and a user password.

16. The remote monitoring control method of the network camera as claimed in claim 15, wherein the elements which are displayed in a form of a cipher are selected from the group consisting of the external address, the external connection port, the user account, and the user password.

17. The remote monitoring control method of the network camera as claimed in claim 1, wherein the operation interface is a web management interface executed on a web browser.

18. The remote monitoring control method of the network camera as claimed in claim 1, wherein the connection for remote monitoring is a connection through a real time streaming data control protocol.
